(19) United States
(12) Patent Application Publication
(10) Pub. No.: US 2011/0161072 A1
(43) Pub. Date: Jun. 30, 2011

(54) LANGUAGE MODEL CREATION APPARATUS, LANGUAGE MODEL CREATION METHOD, SPEECH RECOGNITION APPARATUS, SPEECH RECOGNITION METHOD, AND RECORDING MEDIUM

(75) Inventors: Makoto Terao, Tokyo (JP); Kiyokazu Miki, Tokyo (JP); Hitoshi Yamamoto, Tokyo (JP)

(73) Assignee: NEC CORPORATION, Tokyo (JP)

(21) Appl. No.: 13/059,942

(22) PCT Filed: Aug. 20, 2009
(86) PCT No.: PCT/JP2009/064596

§ 371 Date: Feb. 18, 2011

(30) Foreign Application Priority Data
Aug. 20, 2008 (JP) 2008-211493

(51) Int. Cl. G06F 17/27; G10L 15/06

(52) U.S. Cl. 704/9; 704/244; 704/E15.007

(57) ABSTRACT

A frequency counting unit (15A) counts occurrence frequencies (14B) in input text data (14A) for respective words or word chains contained in the input text data (14A). A context diversity calculation unit (15B) calculates, for the respective words or word chains, diversity indices (14C) each indicating the context diversity of a word or word chain. A frequency correction unit (15C) corrects the occurrence frequencies (14B) of the respective words or word chains based on the diversity indices (14C) of the respective words or word chains. An N-gram language model creation unit (15D) creates an N-gram language model (14E) based on the corrected occurrence frequencies (14D) obtained for the respective words or word chains.

### TECHNICAL FIELD

The present invention relates to a natural language processing technique and, more particularly, to a language model creation technique used in speech recognition, character recognition, and the like.

### BACKGROUND ART

Statistical language models give the generation probabilities of a word sequence and character string, and are widely used in natural language processes such as speech recognition, character recognition, automatic translation, information retrieval, text input, and text correction. A most popular statistical language model is an N-gram language model. The N-gram language model assumes that the generation probability of a word at a certain point depends on only N−1 immediately preceding words.

In the N-gram language model, the generation probability of the ith word wᵢ is given by P(wᵢ|w_{i-N+1}ⁱ⁻¹). The conditional part w_{i-N+1}ⁱ⁻¹ indicates the (i−N+1)th to (i-1)th word sequences. Note that an N=2 model is called bigram, an N=3 model is called trigram, and a model which generates a word without any influence of an immediately preceding word is called a unigram model. According to the N-gram language model, the generation probability P(W₁ⁿ) of the word sequence w₁ⁿ=(w₁, w₂, . . . , wₙ) is given by equation (1):

$$\begin{matrix}[ Mathematical 1 ] & \\ P ( {w}_{i}^{n} ) = {\prod }_{i = 1}^{n} P ( {w}_{i} \vert {w}_{i - N + 1}^{i - 1} ) & ( 1 )\end{matrix}$$

Parameters made from various conditional probabilities of various words in the N-gram language model are obtained by, e.g., maximum likelihood estimation or the like for learning text data. For example, when the N-gram language model is used in speech recognition, character recognition, or the like, a general-purpose model is generally created in advance using a large amount of learning text data. However, the general-purpose N-gram language model created in advance does not always appropriately represent the feature of data to be recognized. Hence, the general-purpose N-gram language model is desirably adapted to data to be recognized.

A typical technique for adapting an N-gram language model to data to be recognized is a cache model (see, e.g., F. Jelinek, B. Merialdo, S. Roukos, M. Strauss, “A Dynamic Language Model for Speech Recognition,” Proceedings of the workshop on Speech and Natural Language, pp. 293-295, 1991). Cache model-based adaptation of a language model utilizes a local word property “the same word or phrase tends to be used repetitively”. More specifically, words and word sequences which appear in data to be recognized are cached, and an N-gram language model is adapted to reflect the statistical properties of words and word sequences in the cache.

In the above technique, when obtaining the generation probability of the ith word wᵢ, a word sequence w_{i-M}ⁱ⁻¹ of immediately preceding M words is cached, and the unigram frequency C(wᵢ), bigram frequency C(wᵢ₋₁,wᵢ), and trigram frequency C(wᵢ₋₂,wᵢ₋₁,wᵢ) of words in the cache are obtained. The unigram frequency C(wᵢ) is the frequency of the word wᵢ which occurs in the word sequence w_{i-M}ⁱ⁻¹. The bigram frequency C(wᵢ₋₁,wᵢ) is the frequency of a 2-word chain which occurs in the word sequence w_{i-M}ⁱ⁻¹. The trigram frequency C(wᵢ₋₂,wᵢ₋₁,wᵢ) is the frequency of a 3-word chain wᵢ₋₂wᵢ₋₁wᵢ which occurs in the word sequence w_{i-M}ⁱ⁻¹. As for the cache length M, for example, a constant of about 200 to 1,000 is experimentally determined.

Based on these pieces of frequency information, the unigram probability Pᵤₙᵢ(wᵢ), bigram probability P_{bi}(wᵢ|wᵢ₋₁), and trigram probability Pₜᵣᵢ(wᵢ|wᵢ₋₂,wᵢ₋₁) of the words are obtained. A cache probability P_{c}(wᵢ|wᵢ₋₂,wᵢ₋₁) is obtained by linearly interpolating these probability values in accordance with equation (2):

[Mathematical 2]

P_{c}(wᵢ|wᵢ₋₂,wᵢ₋₁)=λ₃·Pₜᵣᵢ(wᵢ|wᵢ₋₂,wᵢ₋₁)+λ₂·P_{bi}(wᵢ|wᵢ₋₁)+λ₁·Pᵤₙᵢ(wᵢ) (2)

where λ₁, λ₂, and λ₃ are constants of 0 to 1 which satisfy λ₁+λ₂+λ₃=1 and are experimentally determined in advance. The cache probability P_{c} serves as a model which predicts the generation probability of the word wᵢ based on the statistical properties of words and word sequences in the cache.

A language model P(wᵢ|wᵢ₋₂,wᵢ₋₁) adapted to data to be recognized is obtained by linearly coupling the thus-obtained cache probability P_{c}(wᵢ|wᵢ₋₂,wᵢ₋₁) and the probability P_{B}(wᵢ|wᵢ₋₂,wᵢ₋₁) of a general-purpose N-gram language model created in advance based on a large amount of learning text data in accordance with equation (3):

[Mathematical 3]

P(wᵢ|wᵢ₋₂,wᵢ₋₁)=λ_{C}·P_{C}(wᵢ|wᵢ₋₂,wᵢ₋₁)+(1−λ_{C})+P_{B}(wᵢ|wᵢ₋₂,wᵢ₋₁) (3)

where λ_{c} is a constant of 0 to 1 which is experimentally determined in advance. The adapted language model is a language model which reflects the occurrence tendency of a word or word sequence in data to be recognized.

### DISCLOSURE OF INVENTION

### Problems to be Solved by the Invention

However, the foregoing technique has a problem that a language model which gives a proper generation probability cannot be created for words different in context diversity. The context of a word means words or word sequences present near the word.

The reason why this problem arises will be explained in detail. In the following description, the context of a word is two words preceding the word.

First, a word with high context diversity will be examined. For example, how to give a cache probability P_{c}(wᵢ= [symbol] (t3)|wᵢ₋₂,wᵢ₋₁) appropriate for “ [symbol] [symbol] (t3)” when a word sequence “ . . . , [symbol] (t17), [symbol] (t16), [symbol] (t3), [symbol] (t7), [symbol] (t18), [symbol] (t19), . . . ” appears in the cache during analysis of news about bloom of cherry trees will be considered. Note that the suffix “(tn)” to each word is a sign for identifying the word, and means the nth term. In the following description, the same reference numerals denote the same words.

In this news, “ [symbol] (t3)” does not readily occur only in the same specific context “ [symbol] (t17), [symbol] (t16)” as that in the cache, but is considered to readily occur in various contexts such as “ [symbol] (t6), [symbol] (t7)”, “ [symbol] (t1), [symbol] (t2)”, “ [symbol] (t5), [symbol] (t3)”, and “ [symbol] (t41), [symbol] (t7)”. Thus, the cache probability P_{c}(wᵢ= [symbol] (t3)|wᵢ₋₂,wᵢ₋₁) for “ [symbol] (t3)” should be high regardless of the context wᵢ₋₂,wᵢ₋₁. That is, when a word with high context diversity, like “ [symbol] (t3)”, appears in the cache, the cache probability P_{c} should be high regardless of the context. To increase the cache probability regardless of the context in the above technique, it is necessary to increase λ₁ and decrease λ₃ in equation (2) mentioned above.

To the contrary, a word with poor context diversity will be examined. For example, how to give a cache probability P_{c}(wᵢ= [symbol] (t10)|wᵢ₋₂, wᵢ₋₁) appropriate for “ [symbol] (t10)” when a word sequence “ . . . , [symbol] (t22), [symbol] (t60), [symbol] (t61), [symbol] (t10), . . . ” appears in the cache during analysis of news will be considered. In this news, an expression “. . . [symbol] . . . ”, which is a combination of words, is considered to readily occur. That is, in this news, it is considered that the word “ [symbol] (t10)” readily occurs in the same specific context “ [symbol] [symbol] (t60), [symbol] (t61)” as that in the cache, but does not frequently occur in other contexts. Therefore, the cache probability P_{c}(wᵢ= [symbol] (t10)|wᵢ₋₂, wᵢ₋₁) for “ [symbol] (t10)” should be high restrictively for the same specific context “ [symbol] (t60), [symbol] (t61)” as that in the cache. In other words, when a word with poor context diversity, like “ [symbol] (t10)”, appears in the cache, the cache probability P_{c} should be high only for the same specific context as that in the cache. To increase the cache probability restrictively for the same specific context as that in the cache in the above technique, it is necessary to decrease λ₁ and increase λ₃ in the foregoing equation (2).

In this way, in the above technique, appropriate parameters differ between words different in context diversity, like “ [symbol] (t3)” and “ [symbol] (t10)” exemplified here. In the above technique, however, λ₁, λ₂, and λ₃ need to be constant values regardless of the word wᵢ. Thus, this technique cannot create a language model which gives appropriate generation probabilities to words different in context diversity.

The present invention has been made to solve the above problems, and has as its exemplary object to provide a language model creation apparatus, language model creation method, speech recognition apparatus, speech recognition method, and program capable of creating a language model which gives appropriate generation probabilities to words different in context diversity.

### Means of Solution to the Problems

To achieve the above object, according to the present invention, there is provided a language model creation apparatus comprising an arithmetic processing unit which reads out input text data saved in a storage unit and creates an N-gram language model, the arithmetic processing unit comprising a frequency counting unit which counts occurrence frequencies in the input text data for respective words or word chains contained in the input text data, a context diversity calculation unit which calculates, for the respective words or word chains, diversity indices each indicating diversity of words capable of preceding a word or word chain, a frequency correction unit which calculates corrected occurrence frequencies by correcting occurrence frequencies of the respective words or word chains based on the diversity indices of the respective words or word chains, and an N-gram language model creation unit which creates an N-gram language model based on the corrected occurrence frequencies of the respective words or word chains.

According to the present invention, there is provided a language model creation method of causing an arithmetic processing unit which reads out input text data saved in a storage unit and creates an N-gram language model, to execute a frequency counting step of counting occurrence frequencies in the input text data for respective words or word chains contained in the input text data, a context diversity calculation step of calculating, for the respective words or word chains, diversity indices each indicating diversity of words capable of preceding a word or word chain, a frequency correction step of calculating corrected occurrence frequencies by correcting occurrence frequencies of the respective words or word chains based on the diversity indices of the respective words or word chains, and an N-gram language model creation step of creating an N-gram language model based on the corrected occurrence frequencies of the respective words or word chains.

According to the present invention, there is provided a speech recognition apparatus comprising an arithmetic processing unit which performs speech recognition processing for input speech data saved in a storage unit, the arithmetic processing unit comprising a recognition unit which performs speech recognition processing for the input speech data based on a base language model saved in the storage unit, and outputs recognition result data formed from text data indicating a content of the input speech, a language model creation unit which creates an N-gram language model from the recognition result data based on the above-described language model creation method, a language model adaptation unit which creates an adapted language model by adapting the base language model to the speech data based on the N-gram language model, and a re-recognition unit which performs speech recognition processing again for the input speech data based on the adapted language model.

According to the present invention, there is provided a speech recognition method of causing an arithmetic processing unit which performs speech recognition processing for input speech data saved in a storage unit, to execute a recognition step of performing speech recognition processing for the input speech data based on a base language model saved in the storage unit, and outputting recognition result data formed from text data, a language model creation step of creating an N-gram language model from the recognition result data based on the above-described language model creation method, a language model adaptation step of creating an adapted language model by adapting the base language model to the speech data based on the N-gram language model, and a re-recognition step of performing speech recognition processing again for the input speech data based on the adapted language model.

### Effects of the Invention

The present invention can create a language model which gives appropriate generation probabilities to words different in context diversity.

### BRIEF DESCRIPTION OF DRAWINGS

FIG. 1 is a block diagram showing the basic arrangement of a language model creation apparatus according to the first exemplary embodiment of the present invention;

FIG. 2 is a block diagram showing an example of the arrangement of the language model creation apparatus according to the first exemplary embodiment of the present invention;

FIG. 3 is a flowchart showing language model creation processing of the language model creation apparatus according to the first exemplary embodiment of the present invention;

FIG. 4 exemplifies input text data;

FIG. 5 is a table showing the occurrence frequency of a word;

FIG. 6 is a table showing the occurrence frequency of a 2-word chain;

FIG. 7 is a table showing the occurrence frequency of a 3-word chain;

FIG. 8 is a table showing the diversity index regarding the context of a word “ [symbol] (t3)”;

FIG. 9 is a table showing the diversity index regarding the context of a word “ [symbol] (t10)”;

FIG. 10 is a table showing the diversity index regarding the context of a 2-word chain “ [symbol] (t7), [symbol] (t3)”;

FIG. 11 is a block diagram showing the basic arrangement of a speech recognition apparatus according to the second exemplary embodiment of the present invention;

FIG. 12 is a block diagram showing an example of the arrangement of the speech recognition apparatus according to the second exemplary embodiment of the present invention;

FIG. 13 is a flowchart showing speech recognition processing of the speech recognition apparatus according to the second exemplary embodiment of the present invention; and

FIG. 14 is a view showing speech recognition processing.

### BEST MODE FOR CARRYING OUT THE INVENTION

Exemplary embodiments of the present invention will be described below with reference to the accompanying drawings.

### First Exemplary Embodiment

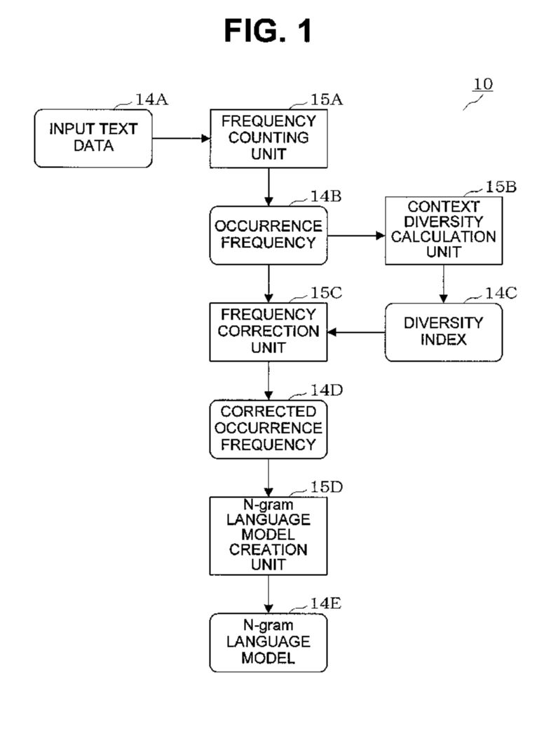

A language model creation apparatus according to the first exemplary embodiment of the present invention will be described with reference to FIG. 1. FIG. 1 is a block diagram showing the basic arrangement of a language model creation apparatus according to the first exemplary embodiment of the present invention.

A language model creation apparatus 10 in FIG. 1 has a function of creating an N-gram language model from input text data. The N-gram language model is a model which obtains the generation probability of a word on the assumption that the generation probability of a word at a certain point depends on only N−1 (N is an integer of 2 or more) immediately preceding words. That is, in the N-gram language model, the generation probability of the ith word wᵢ is given by P(wᵢ|w_{i-N+1}ⁱ⁻¹). The conditional part w_{i-N+1}ⁱ⁻¹ indicates the sequence of the (i−N+1)th to (i−1)th words.

The language model creation apparatus 10 includes, as main processing units, a frequency counting unit 15A, context diversity calculation unit 15B, frequency correction unit 15C, and N-gram language model creation unit 15D.

The frequency counting unit 15A has a function of counting occurrence frequencies 14B in input text data 14A for respective words or word chains contained in the input text data 14A.

The context diversity calculation unit 15B has a function of calculating, for respective words or word chains contained in the input text data 14A, diversity indices 14C each indicating the context diversity of a word or word chain.

The frequency correction unit 15C has a function of correcting, based on the diversity indices 14C of the respective words or word chains contained in the input text data 14A, the occurrence frequencies 14B of the words or word chains, and calculating corrected occurrence frequencies 14D.

The N-gram language model creation unit 15D has a function of creating an N-gram language model 14E based on the corrected occurrence frequencies 14D of the respective words or word chains contained in the input text data 14A.

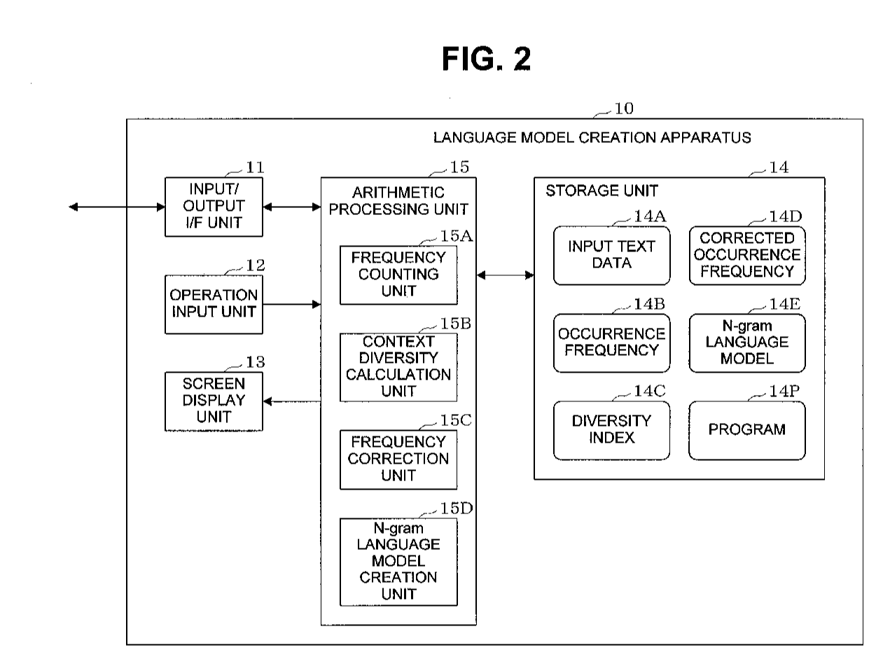

FIG. 2 is a block diagram showing an example of the arrangement of the language model creation apparatus according to the first exemplary embodiment of the present invention.

The language model creation apparatus 10 in FIG. 2 is formed from an information processing apparatus such as a workstation, server apparatus, or personal computer. The language model creation apparatus 10 creates an N-gram language model from input text data as a language model which gives the generation probability of a word.

The language model creation apparatus 10 includes, as main functional units, an input/output interface unit (to be referred to as an input/output I/F unit) 11, operation input unit 12, screen display unit 13, storage unit 14, and arithmetic processing unit 15.

The input/output I/F unit 11 is formed from a dedicated circuit such as a data communication circuit or data input/output circuit. The input/output I/F unit 11 has a function of communicating data with an external apparatus or recording medium to exchange a variety of data such as the input text data 14A, the N-gram language model 14E, and a program 14P.

The operation input unit 12 is formed from an operation input device such as a keyboard or mouse. The operation input unit 12 has a function of detecting an operator operation and outputting it to the arithmetic processing unit 15.

The screen display unit 13 is formed from a screen display device such as an LCD or PDP. The screen display unit 13 has a function of displaying an operation menu and various data on the screen in accordance with an instruction from the arithmetic processing unit 15.

The storage unit 14 is formed from a storage device such as a hard disk or memory. The storage unit 14 has a function of storing processing information and the program 14P used in various arithmetic processes such as language model creation processing performed by the arithmetic processing unit 15.

The program 14P is a program which is saved in advance in the storage unit 14 via the input/output I/F unit 11, and read out and executed by the arithmetic processing unit 15 to implement various processing functions in the arithmetic processing unit 15.

Main pieces of processing information stored in the storage unit 14 are the input text data 14A, occurrence frequency 14B, diversity index 14C, corrected occurrence frequency 14D, and N-gram language model 14E.

The input text data 14A is data which is formed from natural language text data such as a conversation or document, and is divided into words in advance.

The occurrence frequency 14B is data indicating an occurrence frequency in the input text data 14A regarding each word or word chain contained in the input text data 14A.

The diversity index 14C is data indicating the context diversity of each word or word chain regarding the word or word chain contained in the input text data 14A.

The corrected occurrence frequency 14D is data obtained by correcting the occurrence frequency 14B of each word or word chain based on the diversity index 14C of the word or word chain contained in the input text data 14A.

The N-gram language model 14E is data which is created based on the corrected occurrence frequency 14D and gives the generation probability of a word.

The arithmetic processing unit 15 includes a multiprocessor such as a CPU, and its peripheral circuit. The arithmetic processing unit 15 has a function of reading the program 14P from the storage unit 14 and executing it to implement various processing units in cooperation with the hardware and the program 14P.

Main processing units implemented by the arithmetic processing unit 15 are the above-described frequency counting unit 15A, context diversity calculation unit 15B, frequency correction unit 15C, and N-gram language model creation unit 15D. A description of details of these processing units will be omitted.

### Operation in First Exemplary Embodiment

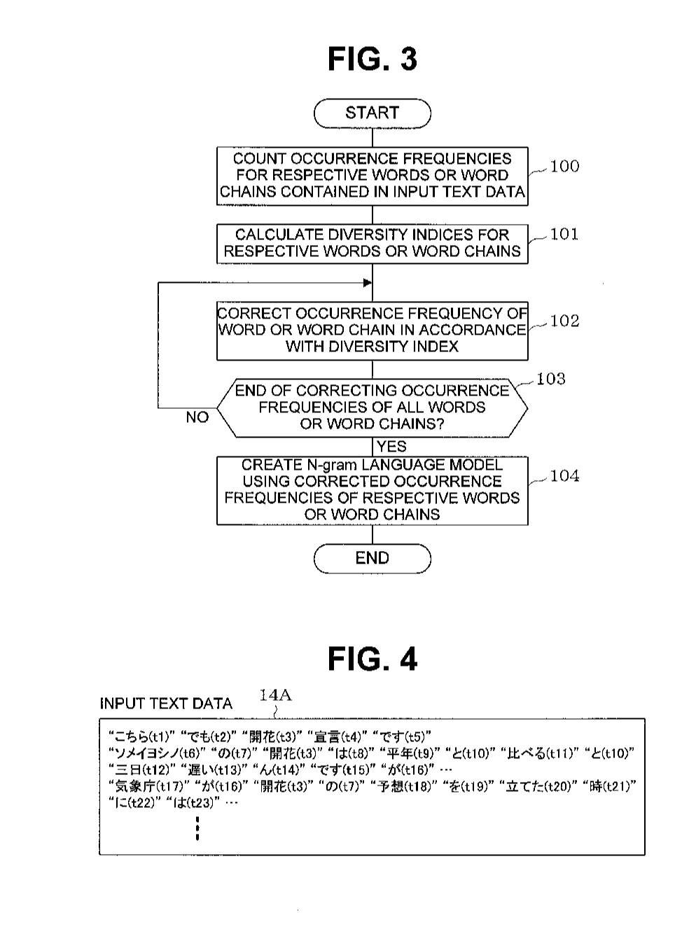

The operation of the language model creation apparatus 10 according to the first exemplary embodiment of the present invention will be explained with reference to FIG. 3. FIG. 3 is a flowchart showing language model creation processing of the language model creation apparatus according to the first exemplary embodiment of the present invention.

When the operation input unit 12 detects a language model creation processing start operation by the operator, the arithmetic processing unit 15 of the language model creation apparatus 10 starts executing the language model creation processing in FIG. 3.

First, the frequency counting unit 15A counts the occurrence frequencies 14B in the input text data 14A for respective words or word chains contained in the input text data 14A in the storage unit 14, and saves them in the storage unit 14 in association with the respective words or word chains (step 100).

FIG. 4 exemplifies input text data. FIG. 4 shows text data obtained by recognizing speech of news about bloom of cherry trees. Each text data is divided into respective words.

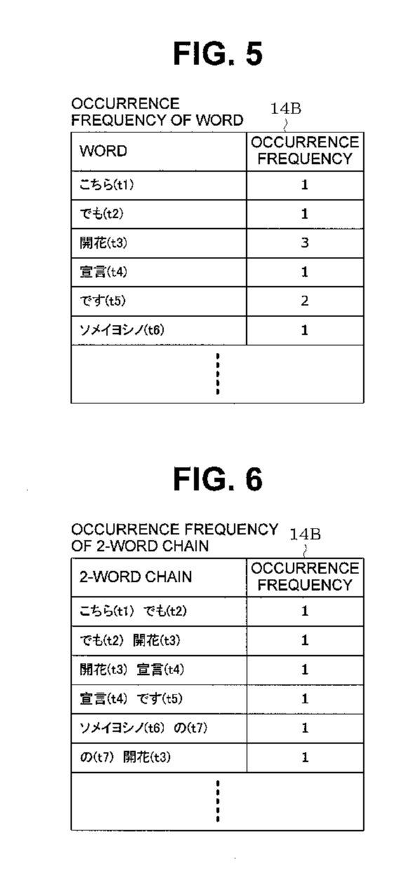

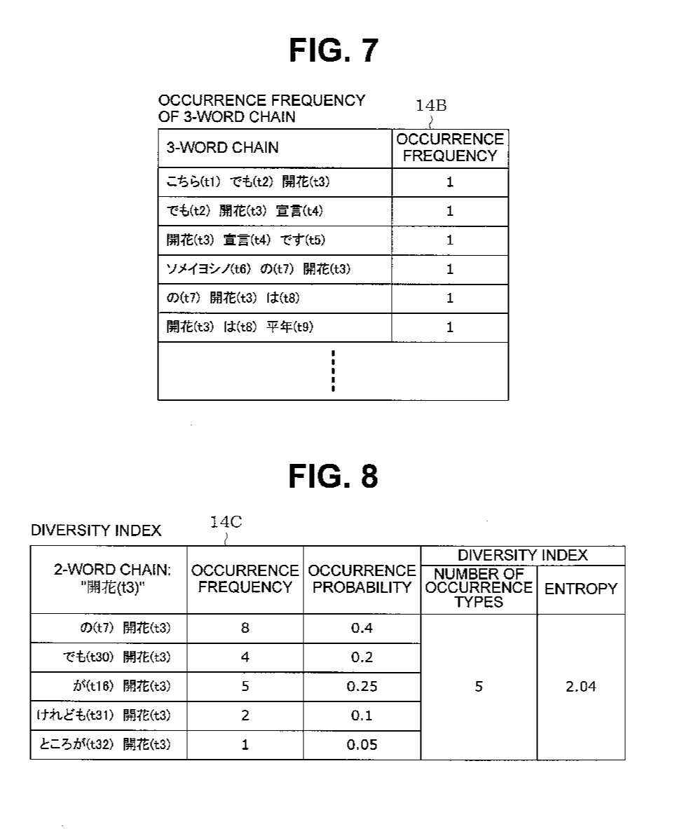

A word chain is a sequence of successive words. FIG. 5 is a table showing the occurrence frequency of a word. FIG. 6 is a table showing the occurrence frequency of a 2-word chain. FIG. 7 is a table showing the occurrence frequency of a 3-word chain. For example, FIG. 5 reveals that a word “ [symbol] (t3)” appears three times and a word “ [symbol] (t4)” appears once in the input text data 14A of FIG. 4. FIG. 6 shows that a 2-word chain “ [symbol] (t3), [symbol] (t4)” appears once in the input text data 14A of FIG. 4. Note that the suffix “(tn)” to each word is a sign for identifying the word, and means the nth term. The same reference numerals denote the same words.

The number of a word to be counted in a chain by the frequency counting unit 15A depends on the N value of an N-gram language model to be created by the N-gram language model creation unit 15D (to be described later). The frequency counting unit 15A needs to count up to at least an N-word chain. This is because the N-gram language model creation unit 15D calculates the N-gram probability based on the occurrence frequency of an N-word chain. For example, when N-gram to be created is trigram (N=3), the frequency counting unit 15A needs to count at least the occurrence frequencies of a word, 2-word chain, and 3-word chain, as shown in FIGS. 5 to 7.

Then, the context diversity calculation unit 15B calculates diversity indices each indicating the diversity of a context, for words or word chains whose occurrence frequencies 14B have been counted, and saves them in the storage unit 14 in association with the respective words or word chains (step 101).

In the present invention, the context of a word or word chain is defined as words capable of preceding the word or word chain. For example, the context of the word “ [symbol] (t4)” in FIG. 5 includes words such as “ [symbol] (t3)”, “ [symbol] (t50)”, and “ [symbol] (t51)” which can precede “ [symbol] (t4)”. The context of the 2-word chain “ [symbol] (t7), [symbol] (t3)” in FIG. 6 includes words such as “ [symbol] (t40)”, “ [symbol] (t42)”, and “ [symbol] (t43)” which can precede “ [symbol] (t7), [symbol] (t3)”. In the present invention, the context diversity of a word or word chain represents how many types of words can precede the word or word chain, or how much the occurrence probabilities of possible preceding words vary.

As a method of obtaining the context diversity of a word or word chain when the word or word chain is given, diversity calculation text data may be prepared to calculate the context diversity. More specifically, diversity calculation text data is saved in the storage unit 14 in advance. The diversity calculation text data is searched for a case in which the word or word chain occurs. Based on the search result, the diversity of a preceding word is checked.

FIG. 8 is a table showing the diversity index regarding the context of the word “ [symbol] (t3)”. For example, when obtaining the context diversity of the word “ [symbol] (t3)”, the context diversity calculation unit 15B collects, from the diversity calculation text data saved in the storage unit 14, cases in which “ [symbol] (t3)” occurs, and lists the respective cases with preceding words. Referring to FIG. 8, the diversity calculation text data reveals that “ [symbol] (t7)” occurred eight times as a word preceding “ [symbol] (t3)”, “ [symbol] (t30)” occurred four times, “ [symbol] (t16)” occurred five times, “ [symbol] (t31)” occurred twice, and “ [symbol] (t32)” occurred once.

At this time, the number of different preceding words in the diversity calculation text data can be set as context diversity. More specifically, in the example of FIG. 8, words preceding “ [symbol] (t3)” are five types of words “ [symbol] (t7)”, “ [symbol] (t30)”, “ [symbol] (t16)”, “ [symbol] [symbol] (t31)”, and “ [symbol] (t32)”, so the diversity index 14C of the context of “ [symbol] (t3)” is 5 in accordance with the number of types. With this setting, the value of the diversity index 14C becomes larger as possible preceding words vary.

The entropy of the occurrence probabilities of preceding words in the diversity calculation text data can also be set as the diversity index 14C of the context. Letting p(w) be the occurrence probability of each word w preceding the word or word chain wᵢ, the entropy H(wᵢ) of the word or word chain wᵢ is given by equation (4):

[Mathematical 4]

H(wᵢ)=Σ_{w}−P(w)log P(w) (4)

In the example shown in FIG. 8, the occurrence probability of each word preceding “ [symbol] (t3)” is 0.4 for “ [symbol] (t7)”, 0.2 for “ [symbol] (t30)”, 0.25 for “ [symbol] (t16)”, 0.1 for “ [symbol] (t31)”, and 0.05 for “ [symbol] (t32)”. As the diversity index 14C of the context of “ [symbol] (t3)”, the entropy of the occurrence probabilities of the respective preceding words is calculated, obtaining H(wᵢ)=−0.4×log 0.4−0.2×log 0.2−0.25×log 0.25−0.1×log 0.1−0.05×log 0.05=2.04. With this setting, the value of the diversity index 14C becomes larger as possible preceding words vary and the variations are greater.

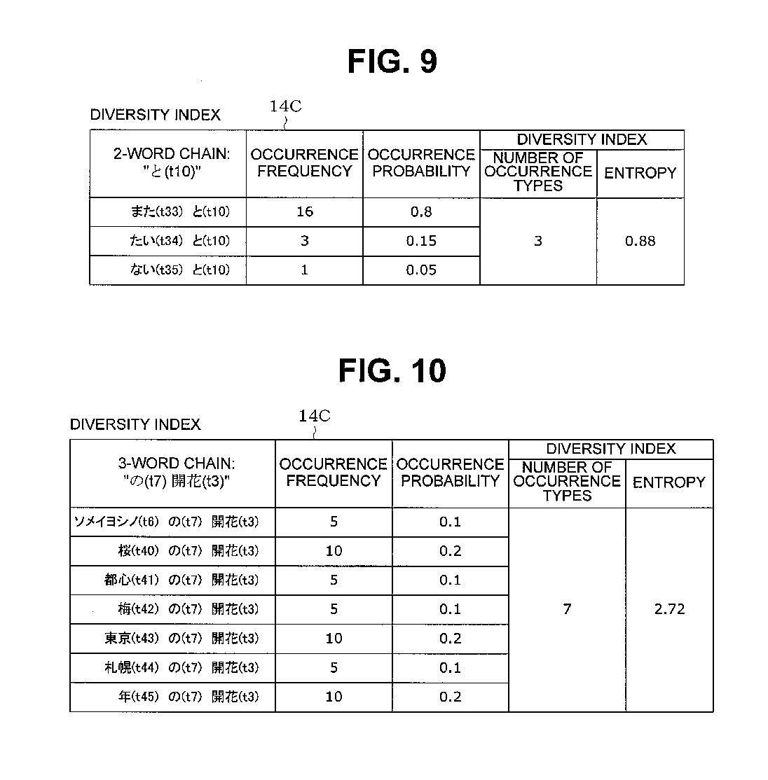

FIG. 9 is a table showing the diversity index regarding the context of the word “ [symbol] (t10)”. Cases in which the word “ [symbol] (t10)” occurs are similarly collected from the diversity calculation text data, and listed together with preceding words. Referring to FIG. 9, the diversity index 14C of the context of “ [symbol] (t10)” is 3 when it is calculated based on the number of different preceding words, and 0.88 when it is calculated based on the entropy of the occurrence probabilities of preceding words. In this manner, a word with poor context diversity has a smaller number of different preceding words and a smaller entropy of occurrence probabilities than those of a word with high context diversity.

FIG. 10 is a table showing the diversity index regarding the context of the 2-word chain “ [symbol] (t7), [symbol] (t3)”. Cases in which the 2-word chain “ [symbol] (t7), [symbol] (t3)” occurs are collected from the diversity calculation text data, and listed together with preceding words. Referring to FIG. 10, the context diversity of “ [symbol] (t7), [symbol] (t3)” is 7 when it is calculated based on the number of different preceding words, and 2.72 when it is calculated based on the entropy of the occurrence probabilities of preceding words. In this fashion, context diversity can be obtained not only for a word but also for a word chain.

Diversity calculation text data prepared is desirably text data of a large volume. As the volume of diversity calculation text data is larger, the occurrence frequency at which a word or word chain whose context diversity is to be obtained occurs is expected to be higher, increasing the reliability of the obtained value. A conceivable example of such large-volume text data is a large-volume newspaper article text. Alternatively, in the exemplary embodiment, text data used to create a base language model 24B used in a speech recognition apparatus 20 (to be described later) may be employed as the diversity calculation text data.

Alternatively, the input text data 14A, i.e., language model learning text data may be used as the diversity calculation text data. In this case, the feature of the context diversity of a word or word chain in the learning text data can be obtained.

In contrast, the context diversity calculation unit 15B can also estimate the context diversity of a given word or word chain based on part-of-speech information of the word or word chain without preparing the diversity calculation text data.

More specifically, a correspondence which determines a context diversity index in advance may be prepared as a table for the type of each part of speech of a given word or word chain, and saved in the storage unit 14. For example, a correspondence table which sets a large context diversity index for a noun and a small context diversity index for a sentence-final particle is conceivable. At this time, as for a diversity index assigned to each part of speech, it suffices to actually assign various values in pre-evaluation experiment and determine an experimentally optimum value.

The context diversity calculation unit 15B suffices to acquire, as a diversity index regarding a word or word chain from the correspondence between each part of speech and its diversity index that is saved in the storage unit 14, a diversity index corresponding to the type of part of speech of the word or that of a word which forms the word chain.

However, it is difficult to assign different optimum diversity indices to all parts of speech. Thus, it is also possible to prepare a correspondence table which assigns different diversity indices depending on only whether the part of speech is an independent word or noun.

By estimating the context diversity of a word or word chain based on part-of-speech information of the word or word chain, the context diversity can be obtained without preparing large-volume context diversity calculation text data.

After that, for the respective words or word chains whose occurrence frequencies 14B have been obtained, the frequency correction unit 15C corrects, in accordance with the diversity indices 14C of contexts that have been calculated by the context diversity calculation unit 15B, the occurrence frequencies 14B of the words or word chains that are stored in the storage unit 14. Then, the frequency correction unit 15C saves the corrected occurrence frequencies 14D in the storage unit 14 (step 102).

At this time, the occurrence frequency of the word or word chain is corrected to be higher for a larger value of the diversity index 14C of the context that has been calculated by the context diversity calculation unit 15B. More specifically, letting C(W) be the occurrence frequency 14B of a given word or word chain W and V(W) be the diversity index 14C, C′(W) indicating the corrected occurrence frequency 14D is given by, e.g., equation (5):

[Mathematical 5]

C′(W)=C(W)×V(W) (5)

In the above-described example, when the diversity index 14C of the context of “ [symbol] (t3)” is calculated based on the entropy from the result of FIG. 8, V( [symbol] =2.04, the occurrence frequency 14B of “ [symbol] (t3)” is (C [symbol] (t3))=3 from the result of FIG. 5, and thus the corrected occurrence frequency 14D is C′( [symbol] (t3))=3×2.04=6.12.

In this manner, the context diversity calculation unit 15B corrects the occurrence frequency to be higher for a word or word chain having higher context diversity. Note that the correction equation is not limited to equation (5) described above, and various equations are conceivable as long as the occurrence frequency is corrected to be higher for a larger V(W).

If the frequency correction unit 15C has not completed correction of all the words or word chains whose occurrence frequencies 14B have been obtained (NO in step 103), it returns to step 102 to correct the occurrence frequency 14B of an uncorrected word or word chain.

Note that the language model creation processing procedures in FIG. 3 represent an example in which the context diversity calculation unit 15B calculates the diversity indices 14C of contexts for all the words or word chains whose occurrence frequencies 14B have been obtained (step 101), and then the frequency correction unit 15C corrects the occurrence frequencies of the respective words or word chains (loop processing of steps 102 and 103). However, it is also possible to simultaneously perform calculation of the diversity indices 14C of contexts and correction of the occurrence frequencies 14B for the respective words or word chains whose occurrence frequencies 14B have been obtained. That is, loop processing may be done in steps 101, 102, and 103 of FIG. 3.

If correction of all the words or word chains whose occurrence frequencies 14B have been obtained is completed (YES in step 103), the N-gram language model creation unit 15D creates the N-gram language model 14E using the corrected occurrence frequencies 14D of these words or word chains, and saves it in the storage unit (step 104). In this case, the N-gram language model 14E is a language model which gives the generation probability of a word depending on only N−1 immediately preceding words.

More specifically, the N-gram language model creation unit 15D first obtains N-gram probabilities using the corrected occurrence frequencies 14D of N-word chains that are stored in the storage unit 14. Then, the N-gram language model creation unit 15D combines the obtained N-gram probabilities by linear interpolation or the like, creating the N-gram language model 14E.

Letting CN(w_{i-N+1}, . . . , wᵢ₋₁, wᵢ) be the occurrence frequency of an N-word chain at the corrected occurrence frequency 14D, an N-gram probability P_{N-gram}(wᵢ|w_{i-N+1}, . . . , wᵢ₋₁) indicating the generation probability of the word wᵢ is given by equation (6):

$$\begin{matrix} [ Mathematical 6 ] & \\ {P}_{N - gram} = ( {w}_{i} \vert {w}_{i - N + 1} , … , {w}_{i - 1} ) = \frac{{C}_{N} ( {w}_{i - N + 1} , … , {w}_{i - 1} , {w}_{i} )}{{\sum }_{w} {C}_{N} ( {w}_{i - N + 1} , … , {w}_{i - 1} , w )} & ( 6 )\end{matrix}$$

Note that a unigram probability P_{unigram}(wᵢ) is obtained from the occurrence frequency C(wᵢ) of the word wᵢ in accordance with equation (7):

$$\begin{matrix}[ Mathematical 7 ] & \\ {P}_{unigram} ( {w}_{i} ) = \frac{C ( {w}_{i} )}{{\sum }_{w} C ( w )} & ( 7 )\end{matrix}$$

The thus-calculated N-gram probabilities are combined, creating the N-gram language model 14E. For example, the respective N-gram probabilities are weighted and linearly interpolated. The following equation (8) represents a case in which a trigram language model (N=3) is created by linearly interpolating a unigram probability, bigram probability, and trigram probability:

[Mathematical 8]

P(wᵢ|wᵢ₋₂,wᵢ₋₁)=λ₃·P_{3-gram}(wᵢ|wᵢ₋₂,wᵢ₋₁)+λ₂·P_{2-gram}(wᵢ|wᵢ₋₁)+λ₁·P_{unigram}(wᵢ) (8)

where λ₂, λ₂, and λ₃ are constants of 0 to 1 which satisfy λ₁+λ₂+λ₃=1. It suffices to actually assign various values in pre-evaluation experiment and experimentally determine optimum values.

As described above, when the frequency counting unit 15A counts up to a word chain having the length N, the N-gram language model creation unit 15D can create the N-gram language model 14E. That is, when the frequency counting unit 15A counts the occurrence frequencies 14B of a word, 2-word chain, and 3-word chain, the N-gram language model creation unit 15D can create a trigram language model (N=3). In creation of the trigram language model, counting the occurrence frequencies of a word and 2-word chain is not always necessary but is desirable.

### Effects of First Exemplary Embodiment

In this way, according to the first exemplary embodiment, the frequency counting unit 15A counts the occurrence frequencies 14B in the input text data 14A for respective words or word chains contained in the input text data 14A. The context diversity calculation unit 15B calculates, for the respective words or word chains contained in the input text data 14A, the diversity indices 14C each indicating the context diversity of a word or word chain. The frequency correction unit 15C corrects the occurrence frequencies 14B of the respective words or word chains based on the diversity indices 14C of the respective words or word chains contained in the input text data 14A. The N-gram language model creation unit 15D creates the N-gram language model 14E based on the corrected occurrence frequencies 14D obtained for the respective words or word chains.

The created N-gram language model 14E is, therefore, a language model which gives an appropriate generation probability even for words different in context diversity. The reason will be explained below.

As for a word with high context diversity, like “ [symbol] (t3)”, the frequency correction unit 15C corrects the occurrence frequency to be higher. In the foregoing example of FIG. 8, when the entropy of the occurrence probabilities of preceding words is used as the diversity index 14C, the occurrence frequency C( [symbol] (t3)) of “ [symbol] (t3)” is corrected to be 2.04 times larger. In contrast, as for a word with poor context diversity, like “ [symbol] (t10)”, the frequency correction unit 15C corrects the occurrence frequency to be smaller than that for a word with high context diversity. In the above example of FIG. 9, when the entropy of the occurrence probabilities of preceding words is used as the diversity index 14C, the occurrence frequency C( [symbol] (t10)) of “ [symbol] (t10)” is corrected to be 0.88 times larger.

Thus, for a word with high context diversity, like “ [symbol] (t3)”, in other words, a word which can occur in various contexts, the unigram probability is high as a result of calculating the unigram probability of each word by the N-gram language model creation unit 15D in accordance with the foregoing equation (7). This means that the language model obtained according to the foregoing equation (8) has a desirable property in which the word “ [symbol] (t3)” readily occurs regardless of the context.

To the contrary, for a word with poor context diversity, like “ [symbol] (t10)”, in other words, a word which restrictively occurs in a specific context, the unigram probability is low as a result of calculating the unigram probability of each word by the N-gram language model creation unit 15D in accordance with the foregoing equation (7). This means that the language model obtained according to the foregoing equation (8) has a desirable property in which the word “ [symbol] (t10)” does not occur regardless of the context.

In this fashion, the first exemplary embodiment can create a language model which gives an appropriate generation probability even for words different in context diversity.

### Second Exemplary Embodiment

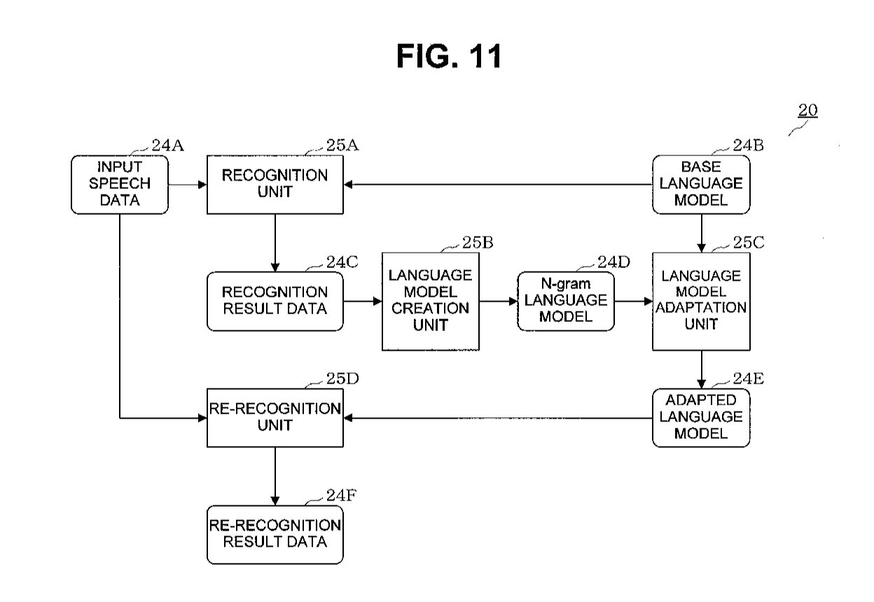

A speech recognition apparatus according to the second exemplary embodiment of the present invention will be described with reference to FIG. 11. FIG. 11 is a block diagram showing the basic arrangement of the speech recognition apparatus according to the second exemplary embodiment of the present invention.

A speech recognition apparatus 20 in FIG. 11 has a function of performing speech recognition processing for input speech data, and outputting text data indicating the speech contents as the recognition result. The speech recognition apparatus 20 has the following feature. A language model creation unit 25B having the characteristic arrangement of the language model creation apparatus 10 described in the first exemplary embodiment creates an N-gram language model 24D based on recognition result data 24C obtained by recognizing input speech data 24A based on a base language model 24B. The input speech data 24A undergoes speech recognition processing again using an adapted language model 24E obtained by adapting the base language model 24B based on the N-gram language model 24D.

The speech recognition apparatus 20 includes, as main processing units, a recognition unit 25A, the language model creation unit 25B, a language model adaptation unit 25C, and a re-recognition unit 25D.

The recognition unit 25A has a function of performing speech recognition processing for the input speech data 24A based on the base language model 24B, and outputting the recognition result data 24C as text data indicating the recognition result.

The language model creation unit 25B has the characteristic arrangement of the language model creation apparatus 10 described in the first exemplary embodiment, and has a function of creating the N-gram language model 24D based on input text data formed from the recognition result data 24C.

The language model adaptation unit 25C has a function of adapting the base language model 24B based on the N-gram language model 24D to create the adapted language model 24E.

The re-recognition unit 25D has a function of performing speech recognition processing for the speech data 24A based on the adapted language model 24E, and outputting re-recognition result data 24F as text data indicating the recognition result.

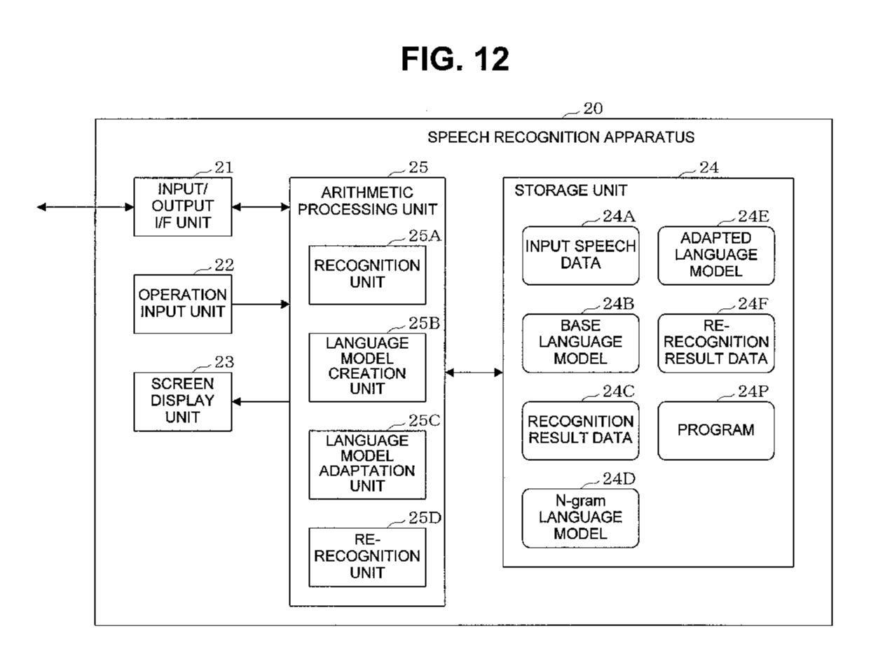

FIG. 12 is a block diagram showing an example of the arrangement of the speech recognition apparatus according to the second exemplary embodiment of the present invention.

The speech recognition apparatus 20 in FIG. 12 is formed from an information processing apparatus such as a workstation, server apparatus, or personal computer. The speech recognition apparatus 20 performs speech recognition processing for input speech data, outputting text data indicating the speech contents as the recognition result.

The speech recognition apparatus 20 includes, as main functional units, an input/output interface unit (to be referred to as an input/output I/F unit) 21, operation input unit 22, screen display unit 23, storage unit 24, and arithmetic processing unit 25.

The input/output I/F unit 21 is formed from a dedicated circuit such as a data communication circuit or data input/output circuit. The input/output I/F unit 21 has a function of communicating data with an external apparatus or recording medium to exchange a variety of data such as the input speech data 24A, the re-recognition result data 24F, and a program 24P.

The operation input unit 22 is formed from an operation input device such as a keyboard or mouse. The operation input unit 22 has a function of detecting an operator operation and outputting it to the arithmetic processing unit 25.

The screen display unit 23 is formed from a screen display device such as an LCD or PDP. The screen display unit 23 has a function of displaying an operation menu and various data on the screen in accordance with an instruction from the arithmetic processing unit 25.

The storage unit 24 is formed from a storage device such as a hard disk or memory. The storage unit 24 has a function of storing processing information and the program 24P used in various arithmetic processes such as language model creation processing performed by the arithmetic processing unit 25.

The program 24P is saved in advance in the storage unit 24 via the input/output I/F unit 21, and read out and executed by the arithmetic processing unit 25, implementing various processing functions in the arithmetic processing unit 25.

Main pieces of processing information stored in the storage unit 24 are the input speech data 24A, base language model 24B, recognition result data 24C, N-gram language model 24D, adapted language model 24E, and re-recognition result data 24F.

The input speech data 24A is data obtained by encoding a speech signal in a natural language, such as conference speech, lecture speech, or broadcast speech. The input speech data 24A may be archive data prepared in advance, or data input on line from a microphone or the like.

The base language model 24B is a language model which is formed from, e.g., a general-purpose N-gram language model learned in advance using a large amount of text data, and gives the generation probability of a word.

The recognition result data 24C is data which is formed from natural language text data obtained by performing speech recognition processing for the input speech data 24A based on the base language model 24B, and is divided into words in advance.

The N-gram language model 24D is an N-gram language model which is created from the recognition result data 24C and gives the generation probability of a word.

The adapted language model 24E is a language model obtained by adapting the base language model 24B based on the N-gram language model 24D.

The re-recognition result data 24F is text data obtained by performing speech recognition processing for the input speech data 24A based on the adapted language model 24E.

The arithmetic processing unit 25 includes a multiprocessor such as a CPU, and its peripheral circuit. The arithmetic processing unit 25 has a function of reading the program 24P from the storage unit 24 and executing it to implement various processing units in cooperation with the hardware and the program 24P.

Main processing units implemented by the arithmetic processing unit 25 are the above-described recognition unit 25A, language model creation unit 25B, language model adaptation unit 25C, and re-recognition unit 25D. A description of details of these processing units will be omitted.

### Operation in Second Exemplary Embodiment

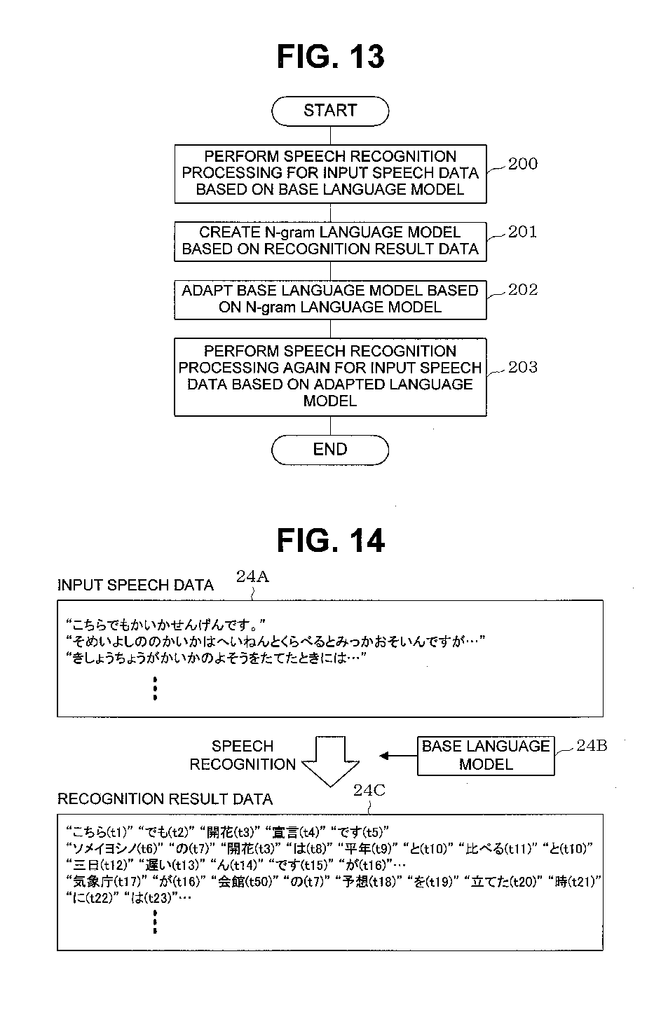

The operation of the speech recognition apparatus 20 according to the second exemplary embodiment of the present invention will be explained with reference to FIG. 13. FIG. 13 is a flowchart showing speech recognition processing of the speech recognition apparatus 20 according to the second exemplary embodiment of the present invention.

When the operation input unit 22 detects a speech recognition processing start operation by the operator, the arithmetic processing unit 25 of the speech recognition apparatus 20 starts executing the speech recognition processing in FIG. 13.

First, the recognition unit 25A reads the speech data 24A saved in advance in the storage unit 24, converts it into text data by applying known large vocabulary continuous speech recognition processing, and saves the text data as the recognition result data 24C in the storage unit 24 (step 200). At this time, the base language model 24B saved in the storage unit 24 in advance is used as a language model for speech recognition processing. An acoustic model is, e.g., one based on a known HMM (Hidden Markov Model) using a phoneme as the unit.

FIG. 14 is a view showing speech recognition processing. In general, the result of large vocabulary continuous speech recognition processing is obtained as a word sequence, so the recognition result text is divided in units of words. Note that FIG. 14 shows recognition processing for the input speech data 24A formed from news speech about bloom of cherry trees. In the obtained recognition result data 24C, “ [symbol] (t50)” is a recognition error of “ [symbol] (t4)”.

Then, the language model creation unit 25B reads out the recognition result data 24C saved in the storage unit 24, creates the N-gram language model 24D based on the recognition result data 24C, and saves it in the storage unit 24 (step 201). At this time, as shown in FIG. 1 described above, the language model creation unit 25B includes a frequency counting unit 15A, context diversity calculation unit 15B, frequency correction unit 15C, and N-gram language model creation unit 15D as the characteristic arrangement of the language model creation apparatus 10 according to the first exemplary embodiment. In accordance with the above-described language model creation processing in FIG. 3, the language model creation unit 25B creates the N-gram language model 24D from input text data formed from the recognition result data 24C. Details of the language model creation unit 25B are the same as those in the first exemplary embodiment, and a detailed description thereof will not be repeated.

Thereafter, the language model adaptation unit 25C adapts the base language model 24B in the storage unit 24 based on the N-gram language model 24D in the storage unit 24, creating the adapted language model 24E and saving it in the storage unit 24 (step 202). More specifically, it suffices to combine, e.g., the base language model 24B and N-gram language model 24D by linear coupling, creating the adapted language model 24E.

The base language model 24B is a general-purpose language model used in speech recognition by the recognition unit 25A. In contrast, the N-gram language model 24D is a language model which is created using the recognition result data 24C in the storage unit 24 as learning text data, and reflects a feature specific to the speech data 24A to be recognized. It can therefore be expected to obtain a language model suited to speech data to be recognized, by linearly coupling these two language models.

Subsequently, the re-recognition unit 25D performs speech recognition processing again for the speech data 24A stored in the storage unit 24 using the adapted language model 24E, and saves the recognition result as the re-recognition result data 24F in the storage unit 24 (step 203). At this time, the recognition unit 25A may obtain the recognition result as a word graph, and save it in the storage unit 24. The re-recognition unit 25D may rescore the word graph stored in the storage unit 24 by using the adapted language model 24E, and output the re-recognition result data 24F.

### Effects of Second Exemplary Embodiment

As described above, according to the second exemplary embodiment, the language model creation unit 25B having the characteristic arrangement of the language model creation apparatus 10 described in the first exemplary embodiment creates the N-gram language model 24D based on the recognition result data 24C obtained by recognizing the input speech data 24A based on the base language model 24B. The input speech data 24A undergoes speech recognition processing again using the adapted language model 24E obtained by adapting the base language model 24B based on the N-gram language model 24D.

An N-gram language model obtained by the language model creation apparatus according to the first exemplary embodiment is considered to be effective especially when the amount of learning text data is relatively small. When the amount of learning text data is small, like speech, it is considered that learning text data cannot cover all contexts of a given word or word chain. For example, assuming that a language model about bloom of cherry trees is to be built, a word chain ( [symbol] (t40), [symbol] (t7), [symbol] (t3)) may appear in learning text data but a word chain ( [symbol] (t40), [symbol] (t16), [symbol] (t3)) may not appear if the amount of learning text data is small. In this case, if an N-gram language model is created based on, e.g., the above-described related art, the generation probability of a sentence “ [symbol] . . .” becomes very low. This adversely affects the prediction accuracy of a word with poor context diversity, and decreases the speech recognition accuracy.

However, according to the present invention, since the context diversity of the word “ [symbol] (t3)” is high, the unigram probability of “ [symbol] (t3)” rises regardless of the context only when ( [symbol] (t40), [symbol] (t7), [symbol] [symbol] (t3)) appears in learning text data. This can increase even the generation probability of a sentence “ [symbol] . . . ” Further, the unigram probability does not rise for a word with poor context diversity. Accordingly, the speech recognition accuracy is maintained without adversely affecting the prediction accuracy of a word with poor context diversity.

In this fashion, the language model creation apparatus according to the present invention is effective particularly when the amount of learning text data is small. A very effective language model can therefore be created by creating an N-gram language model from recognition result text data of input speech data in speech recognition processing as described in the exemplary embodiment. By coupling the obtained language model to an original base language, a language model suited to input speech data to be recognized can be attained, greatly improving the speech recognition accuracy.

### Extension of Exemplary Embodiments

The present invention has been described by referring to the exemplary embodiments, but the present invention is not limited to the above exemplary embodiments. It will readily occur to those skilled in the art that various changes can be made for the arrangement and details of the present invention within the scope of the invention.

Also, the language model creation technique, and further the speech recognition technique have been explained by exemplifying Japanese. However, these techniques are not limited to Japanese, and can be applied in the same manner as described above to all languages in which a sentence is formed from a chain of words, obtaining the same operation effects as those described above.

This application is based upon and claims the benefit of priority from Japanese Patent Application No. 2008-211493, filed on Aug. 20, 2008, the disclosure of which is incorporated herein in its entirety by reference.

### INDUSTRIAL APPLICABILITY

The present invention is applicable for use in various automatic recognition systems which output text information as a result of speech recognition, character recognition, and the like, and programs for implementing an automatic recognition system in a computer. The present invention is also applicable for use in various natural language processing systems utilizing statistical language models.

1. A language model creation apparatus comprising an arithmetic processing unit which reads out input text data saved in a storage unit and creates an N-gram language model,
said arithmetic processing unit comprising:
a frequency counting unit which counts occurrence frequencies in the input text data for respective words or word chains contained in the input text data;
a context diversity calculation unit which calculates, for the respective words or word chains, diversity indices each indicating diversity of words capable of preceding a word or word chain;
a frequency correction unit which calculates corrected occurrence frequencies by correcting occurrence frequencies of the respective words or word chains based on the diversity indices of the respective words or word chains; and
an N-gram language model creation unit which creates an N-gram language model based on the corrected occurrence frequencies of the respective words or word chains.

2. A language model creation apparatus according to claim 1, wherein said context diversity calculation unit searches diversity calculation text data saved in the storage unit for each word preceding the word or word chain, and calculates the diversity index regarding the word or word chain based on a search result.

3. A language model creation apparatus according to claim 2, wherein said context diversity calculation unit calculates, based on occurrence probabilities of words preceding the word or word chain that are calculated based on the search result, an entropy of the occurrence probabilities as the diversity index regarding the word or word chain.

4. A language model creation apparatus according to claim 3, wherein said frequency correction unit corrects the occurrence frequency to be larger for a word or word chain having a larger entropy.

5. A language model creation apparatus according to claim 2, wherein said context diversity calculation unit calculates, as the diversity index regarding the word or word chain, the number of different words preceding the word or word chain based on the search result.

6. A language model creation apparatus according to claim 5, wherein said frequency correction unit corrects the occurrence frequency to be larger for a word or word chain having a larger number of different words.

7. A language model creation apparatus according to claim 1, wherein said context diversity calculation unit acquires, as the diversity index regarding the word or word chain, a diversity index corresponding to a type of part of speech of a word which forms the word or word chain in a correspondence between a type of each part of speech saved in the storage unit and a diversity index of the type of each part of speech.

8. A language model creation apparatus according to claim 7, wherein said frequency correction unit corrects the occurrence frequency to be larger for a word or word chain having a larger diversity index.

9. A language model creation apparatus according to claim 7, wherein the correspondence determines different diversity indices depending on whether the part of speech is an independent word or a noun.

10. A language model creation method of causing an arithmetic processing unit which reads out input text data saved in a storage unit and creates an N-gram language model, to execute
a frequency counting step of counting occurrence frequencies in the input text data for respective words or word chains contained in the input text data,
a context diversity calculation step of calculating, for the respective words or word chains, diversity indices each indicating diversity of words capable of preceding a word or word chain,
a frequency correction step of calculating corrected occurrence frequencies by correcting occurrence frequencies of the respective words or word chains based on the diversity indices of the respective words or word chains, and
an N-gram language model creation step of creating an N-gram language model based on the corrected occurrence frequencies of the respective words or word chains.

11. (canceled)

12. A speech recognition apparatus comprising an arithmetic processing unit which performs speech recognition processing for input speech data saved in a storage unit,
said arithmetic processing unit comprising:
a recognition unit which performs speech recognition processing for the input speech data based on a base language model saved in the storage unit, and outputs recognition result data formed from text data indicating a content of the input speech;
a language model creation unit which creates an N-gram language model from the recognition result data based on a language model creation method defined in claim 10;
a language model adaptation unit which creates an adapted language model by adapting the base language model to the speech data based on the N-gram language model; and
a re-recognition unit which performs speech recognition processing again for the input speech data based on the adapted language model.

13. A speech recognition method of causing an arithmetic processing unit which performs speech recognition processing for input speech data saved in a storage unit, to execute
a recognition step of performing speech recognition processing for the input speech data based on a base language model saved in the storage unit, and outputting recognition result data formed from text data,
a language model creation step of creating an N-gram language model from the recognition result data based on a language model creation method defined in claim 10,
a language model adaptation step of creating an adapted language model by adapting the base language model to the speech data based on the N-gram language model, and
a re-recognition step of performing speech recognition processing again for the input speech data based on the adapted language model.

14. (canceled)

15. A recording medium recording a program for causing a computer including an arithmetic processing unit which reads out input text data saved in a storage unit and creates an N-gram language model, to execute, by using the arithmetic processing unit,
a frequency counting step of counting occurrence frequencies in the input text data for respective words or word chains contained in the input text data,
a context diversity calculation step of calculating, for the respective words or word chains, diversity indices each indicating diversity of words capable of preceding a word or word chain,
a frequency correction step of calculating corrected occurrence frequencies by correcting occurrence frequencies of the respective words or word chains based on the diversity indices of the respective words or word chains, and
an N-gram language model creation step of creating an N-gram language model based on the corrected occurrence frequencies of the respective words or word chains.

16. A recording medium recording a program for causing a computer including an arithmetic processing unit which performs speech recognition processing for input speech data saved in a storage unit, to execute, by using the arithmetic processing unit,
a recognition step of performing speech recognition processing for the input speech data based on a base language model saved in the storage unit, and outputting recognition result data formed from text data,
a language model creation step of creating an N-gram language model from the recognition result data based on a language model creation method defined in claim 10,
a language model adaptation step of creating an adapted language model by adapting the base language model to the speech data based on the N-gram language model, and
a re-recognition step of performing speech recognition processing again for the input speech data based on the adapted language model.
